(19) United States
(12) Patent Application Publication
(10) Pub. No.: US 2008/0053013 A1
(43) Pub. Date: Mar. 6, 2008

(54) DRYWALL BACKING APPARATUS AND METHOD OF INSTALLING SAME

(76) Inventor: Daniel W. Tollenaar, Des Moines, IA (US)

Correspondence Address: STURM & FIX LLP, 206 SIXTH AVENUE, SUITE 1213, DES MOINES, IA, 50309-4076, US

(21) Appl. No.: 11/930,607

(22) Filed: Oct. 31, 2007

Related U.S. Application Data
(62) Division of application No. 10/693,350, filed on Oct. 24, 2003.

(51) Int. Cl. E06B 1/34

(52) U.S. Cl. 52/212

(57) ABSTRACT

A method and apparatus for installing backing in walls which include a first, second and third upright U-shaped stud. A first backing member has a first end, a second end, a top, a bottom, a first side and a second side. The first backing member is disposed between the first and second studs. A second backing member has a first end, a second end, a top, a bottom, a first side and a second side. The second backing member is disposed between said second and third studs. A hinge is operatively attached to the first side of the first and second backing members for permitting the second backing member to pivot with respect the first backing member between a first position wherein the first side of each of the first and second backing members are substantially in the same plane and a second position whereby the first and second backing members are not in the same plane. This permits the first backing member to be placed between a first and second adjacent vertical stud. Then the second backing member is pivoted with respect to the first backing member. After that, the second backing member is pivoted to a position to be disposed between the second vertical stud and the third stud which is adjacent to said second stud, whereby the second end of the first backing member is adjacent to and on one side of the first stud and the first end of the second backing member is adjacent to and on the other side of the first stud. More than two backing members can be tied together with a hinge if desired.

### BACKGROUND OF THE INVENTION

1. Field of the Invention

The present invention relates to wall construction, and more particularly to a method and apparatus for anchoring wall mounted structures such as handrails and grab bars.

2. Description of Prior Art

Historically, the framework of a building wall was formed entirely of wood members, including wooden studs. In recent years at least in the United States, however, the use of metal studs has gained acceptance, especially in commercial buildings, such as office buildings and hospitals. It has been found that metal studs can be advantageously employed, since a suitable metal, such as galvanized steel, is stronger than wood, will not rot, is not subject to damage by pests such as termites, remains resistant to fire, and is economically feasible.

Metal studs are typically formed of sheet metal bent to encompass a cross sectional area having nominal dimensions of two inches by four inches. To conform to architectural plans and building code requirements, metal studs are formed of sheet metal bent into a generally U-shaped cross-section in which a relatively broad central base is flanked by a pair of narrower sides that are bent at right angles to the base. The base typically has a uniform nominal width of either four inches or 3 [symbol] inches, which is commonly referred to as the web. The sides of the U-shaped stud typically extends to a nominal distance of two inches from the base which are commonly referred to as flanges. To enhance structural rigidity to the flanges of the stud, the flanges are normally bent over into a plane parallel to and spaced from the plane of the web. These turned over edges of the sides thereby form marginal lips which are typically one quarter to one half inch in width. Conventionally, the metal studs are erected with the webs oriented on the same side in the same direction.

In building construction, there are certain situations which require the building studs to be braced or linked transversely to provide enhanced structural rigidity. The studs must be transversely bridged when they are over eight feet in length so that they provide adequate stability in a lateral direction within the wall which they support.

In certain instances, the metal studs require transverse backing between the studs in a building so to provide structural support against forces acting normal to or parallel to the plane of the wall assembly. For example, structural backing must be provided between adjacent parallel studs to provide necessary structural stability for the installation wall structures such as hand rails and grab bars most which conform to requirements of the Americans with Disabilities Act, i.e., withstand 250 pounds of point load pressure outward and downward parallel to the plane of the wall. A common way to provide backing is to shape pieces of plywood between adjacent studs and use screw fasteners to attach these pieces to adjacent studs. The number and placement of backing plywood pieces is determined by how much of the framework needs backing.

The use of fire-stops, bridging and backing in construction trade is well known in the prior art. Construction Codes and Fire Codes requires that these devices be positioned between metal studs to: (1) reinforce uniformly laterally spaced parallel metal studs; (2) discourage the spread of fire, smoke and gases within interior walls; and (3) anchor hand rails and grab bars to metal studs. Typically, sheetrock covers the studs and backing and is attached thereto.

### BRIEF SUMMARY OF THE INVENTION

The present invention relates to a method and apparatus for installing backing in walls which include a first, second and third upright U-shaped stud. A first backing member has a first end, a second end, a top, a bottom, a first side and a second side. The first backing member is disposed between the first and second studs. A second backing member has a first end, a second end, a top, a bottom, a first side and a second side. The second backing member is disposed between said second and third studs. A hinge is operatively attached to the first side of the first and second backing members for permitting the second backing member to pivot with respect the first backing member between a first position wherein the first side of each of the first and second backing members are substantially in the same plane and a second position whereby the first and second backing members are not in the same plane. This permits the first backing member to be placed between a first and second adjacent vertical stud. Then the second backing member is pivoted with respect to the first backing member. After that, the second backing member is pivoted to a position to be disposed between the second vertical stud and the third stud which is adjacent to said second stud, whereby the second end of the first backing member is adjacent to and on one side of the first stud and the first end of the second backing member is adjacent to and on the other side of the first stud. More than two backing members can be tied together with a hinge if desired.

Therefore, an object of the present invention is the provision of an improved dry wall backing apparatus and method of installing same.

Another object is to provide a fire break structure.

Other objects, advantages, and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a partial perspective view of a plurality of metal studs having the present invention attached thereto;

FIG. 2 is a preferred embodiment of the present invention shown in a perspective view;

FIG. 3 is a cross sectional view taken along line 3-3 of FIG. 2;

FIG. 4 is a cross sectional view taken along line 4-4 of FIG. 2;

FIG. 5 is a partial front view of a right side portion of the invention shown in FIG. 2;

FIG. 6 is a perspective view from the back side of that shown in FIG. 1 in a perspective view;

FIG. 7 is a top view showing how the invention is placed onto a pair of metal U-shaped studs;

FIG. 8 is a partial perspective view showing how a fire break portion is attached;

FIG. 9 is a perspective view showing how a bottom fire break member can also be attached if desired;

FIG. 10 is a cross sectional view taken along line 10-10 of FIG. 9;

FIG. 11 shows an alternate view of the present invention showing projections formed in a sheet metal hinge to attach to wooden pieces by pushing the projections into the wood;

FIG. 12 is an enlarged prospective view of the projections shown in FIG. 11;

FIG. 13 is a cross sectional view taken along line 13-13 of FIG. 1 showing another aspect of the present invention which is a backing member with a flange on one end thereof for quick attachment to adjacent studs and which can be used on the corners where the studs may not be a standard sixteen inches apart;

FIG. 14 is a perspective view showing the invention of FIG. 13;

FIG. 15 is a perspective view of the flange which is attached to a wooden member of FIG. 13; and

FIG. 16 is an alternate form of the flange and showing how a piece of wood can be received in a depression therein.

### DETAILED DESCRIPTION OF THE BEST MODES OF THE INVENTION

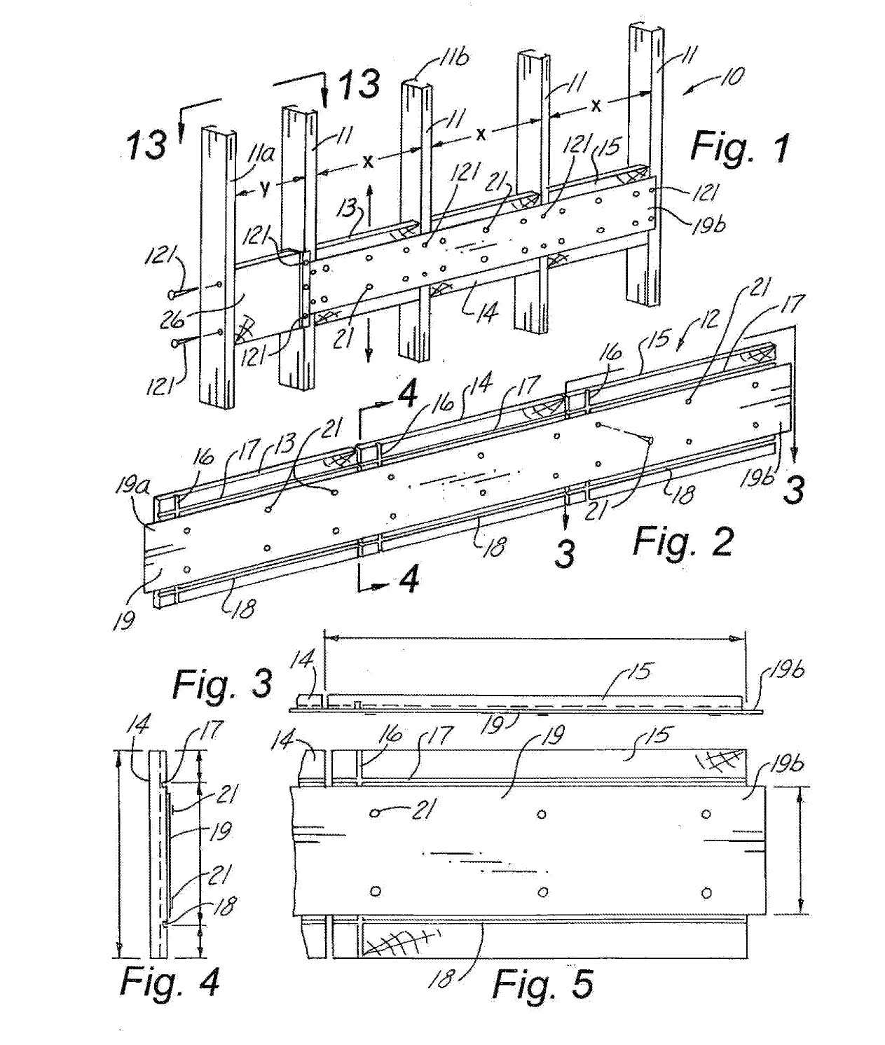

Referring now to the drawings, wherein like reference numerals designate identical or corresponding parts throughout the several views, FIG. 1 shows the present invention in use as a unit as indicated by the structure (10). Upright metal studs (11) are spaced equally apart and a stud (11a) is spaced a distance (y) which is shorter than the distance (x) that the other studs (11) are spaced from each other. This invention can also be used with studs (11) in ceilings or floors.

Referring to FIG. 2, a backing structure (12) is shown in a preferred embodiment which has three wooden backing members (13), (14) and (15) each having vertical grooves (16) on one end thereof and top and bottom horizontal grooves (17) and (18). A flexible metal hinge (19) is in a preferred embodiment constructed of galvanized sheet metal such as steel but could be any other flexible material. This flexible metal piece (19) serves as a hinge between the first backing member (13) and the second backing member (14) and likewise forms a hinge between the second backing member (14) and the third backing member (15). This hinge (19) could also be any kind of a hinge, for example, between the first backing member (13) and the second backing member (14) and does not need to be a one-piece member with a hinge between the second backing member (14) and the third backing member (15). It is, however, advantageous to have piece (19) extend from beyond the left side of backing member (13) to the right side of the third backing member (15) as shown in FIG. 2 because, not only does it then serve as a double hinge, but also the protruding edges on both ends thereof can easily be attached to the studs (11) as will be described below. The backing members (13), (14) and (15) in this preferred embodiment are constructed of plywood, but they could be a solid piece of wood or any other suitable material useful as a backing member. Screws (21) are used to attach the sheet metal member (19) to each of the backing members (13), (14) and (15), but other ways of attaching the hinge (19) to the backing members (13), (14) or (15) would be fully equivalent thereto.

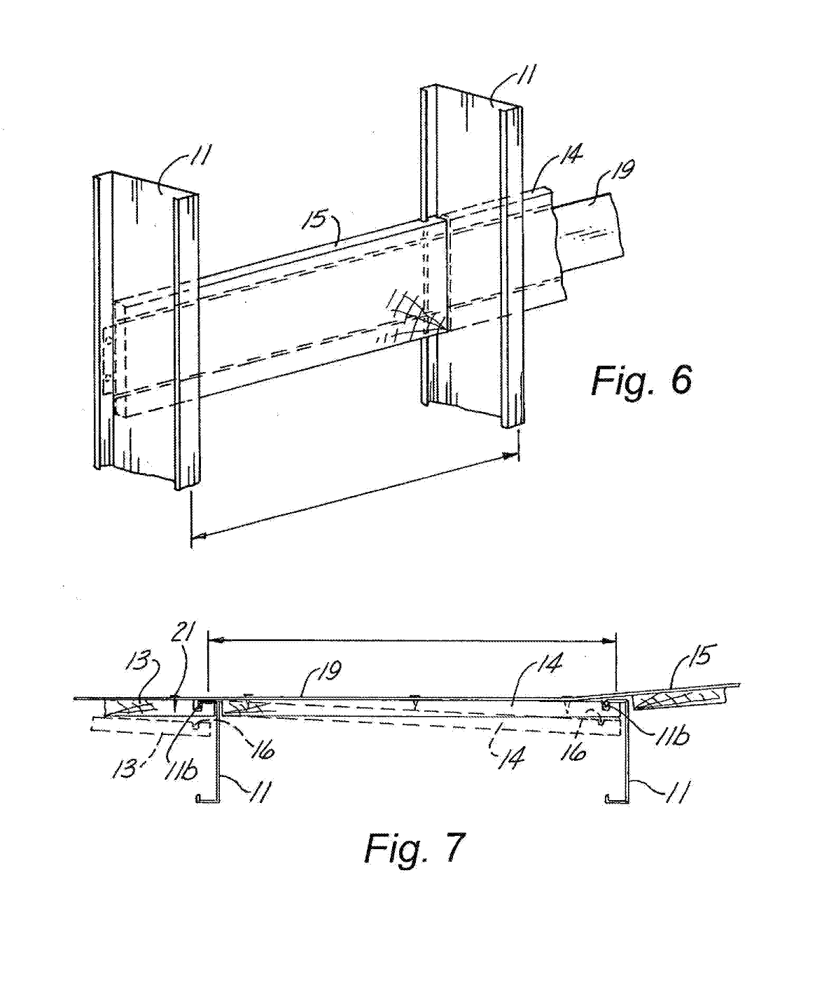

Referring now to FIGS. 1, 6 and 7, it will be appreciated how easily the apparatus (12) can be attached to the studs (11). For example, as shown in FIG. 7, the first backing member (13) can be easily placed from the dashed line view to the solid line view by pivoting the hinge (19) at approximately the place where the attaching screws (21) are on the left side of FIG. 7. This will allow the vertical groove (16) to go around a flange (11b) in stud (11).

The next step is to pivot the hinge (19) so that the second backing member (14) moves from the position shown in dashed lines in FIG. 7 to the position shown in solid lines in FIG. 7 wherein the vertical groove (16) will be moved over the flange extension (11b) of stud (11), the left stud (11) being the second stud and the right stud in FIG. 7 being the third stud of the four studs shown in FIG. 1 as stud (11).

After the first backing member (13) and the second backing member (14) are in the position shown in solid lines in FIG. 7, then the third backing member (15) is pivoted from the solid line position shown in FIG. 7 to the solid line position shown in FIG. 1. Fasteners (121) are like screws (21). Fasteners (121) attach the end portion (19a) and (19b) of the hinge (19) to the studs (11) over which they lie. After that has been done, screws (121) are also attached through middle portions of the hinge (19) to respective studs (11) as is clearly shown in FIG. 1. It will therefore be appreciated that this is much quicker and forms a more solid unit than merely trying to fasten the wood backing members (13), (14) and (15) individually to studs (11) without use of the sheet metal hinge (19).

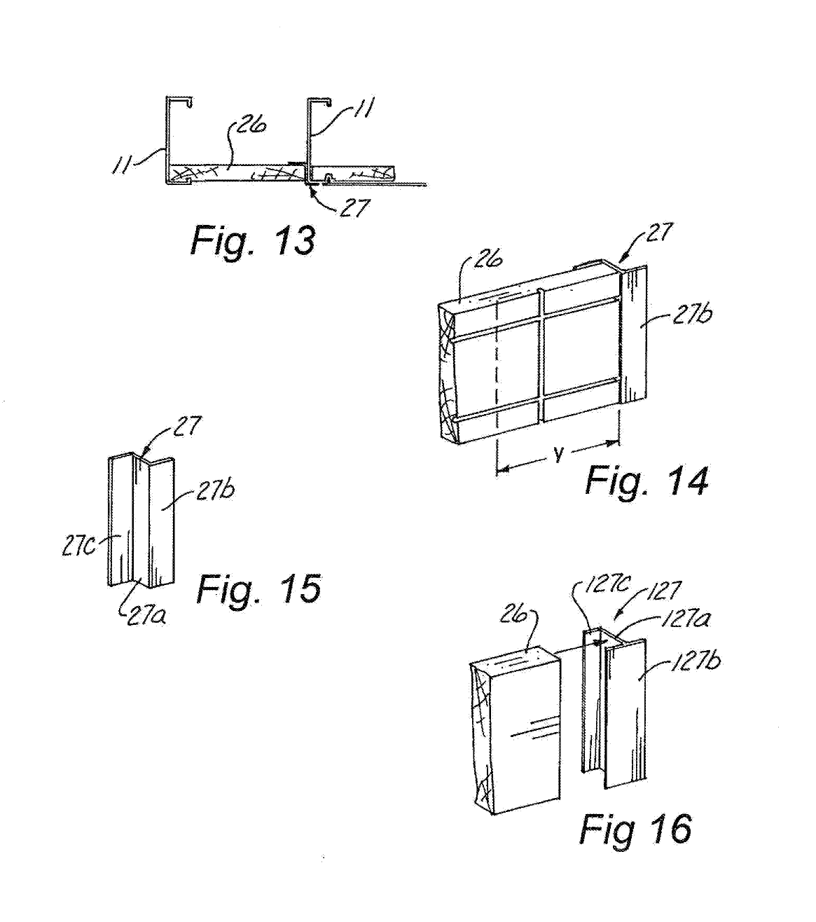

Typically, on the corners of a structure, the stud (11a) shown in FIG. 1 is a distance (y) which is less than the standard distance (x) between the other studs (11) in the wall except for the opposite corner. In order to facilitate quick and easy backing, a backing member (26) made preferably of wood, but which can be made of other materials, has a flange member (27) attached to one end thereof as shown in FIGS. 13, 14 and 15. Screws (121) extend through the end of the wood in center portion (27a) of flange (27) and then screws (121), also extend through flange portion (27b) and into the first stud (11) shown in FIG. 1. FIG. 14 shows vertical and horizontal grooves in the front face, but these are strictly optional in this end piece option (26).

Alternatively, a member (127) as shown in FIG. 16 can be used to receive the end of wooden piece (26) and is fully equivalent to the structure shown in FIGS. 13-15. Member (127) has flanges (127a), (127b) and (127c). Also, these structures shown in FIGS. 13-16 can be used independently of the invention shown in FIG. 2 and is a quicker and more economical solution, especially from a labor standpoint, than merely attaching wooden pieces as backing members as in the prior art without the flanges (27) and (127).

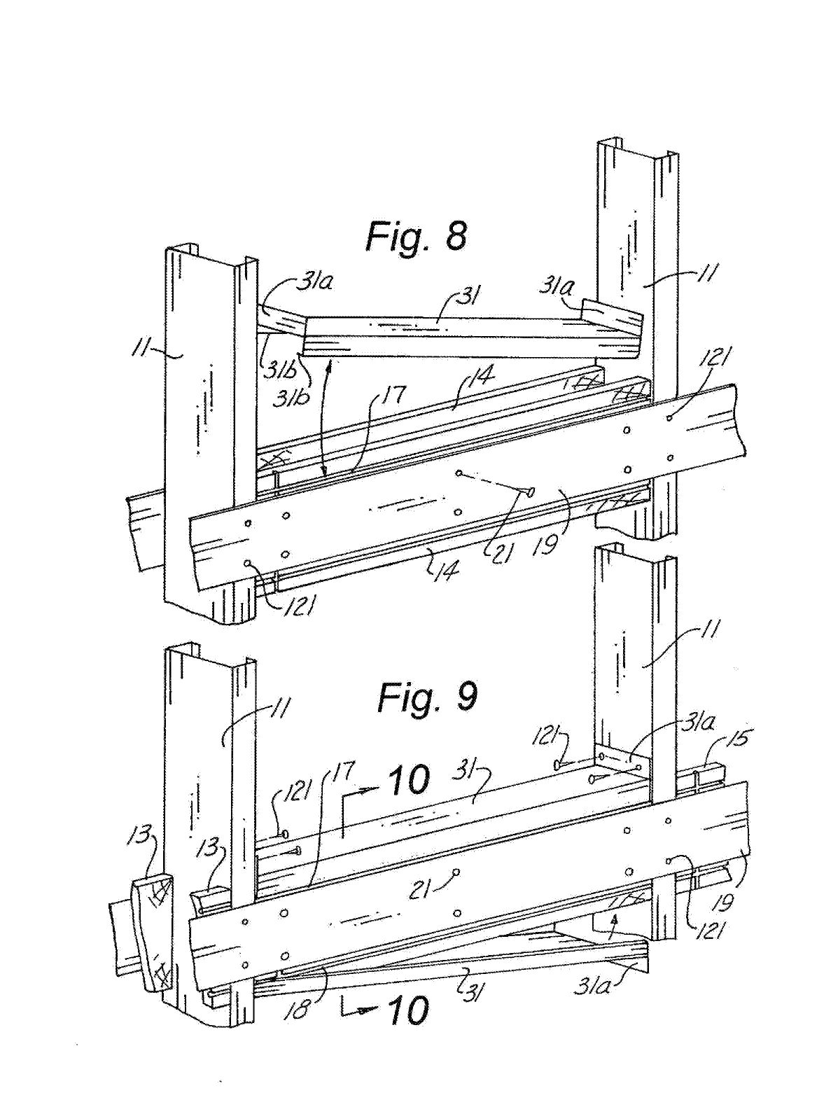

Referring now to FIG. 8, a fire break member (31) is cut from a piece of stud, like studs (11) shown in FIG. 1. The ends (31a) can be folded up if desired and although this is a preferred embodiment, the fire break (31) would not have to extend the entire distance if it were merely used as a support member. But it works better as both a support member and a fire break in the preferred embodiment shown in FIGS. 8 and 9. The flange (31b) extends into the horizontal groove (17) of the second backing member (17) as shown in FIG. 8 and a flange (31b) on the other side will extend into a similar groove (17) in a rear second backing member (14) as well. These flanges (31b) can be separated slightly and they are naturally biased into the groove (17) to form an extremely strong structure in conjunction with backing members (14) and studs (11). The end flanges (31a) can also be attached by screws (121) to the studs (11) which further strengthens the entire structure.

If desired, this entire structure can be further strengthened by adding a second fire break member (31) on the bottom side as shown in FIG. 9, which would be attached just like the member (31) on the top, shown in FIG. 8. When constructed like the preferred embodiment shown in FIGS. 8 and 9, it forms a combination backing structure fire break and structural component which is unsurpassed by anything in the prior art. It can also be constructed quicker and more economically than anything heretofore available.

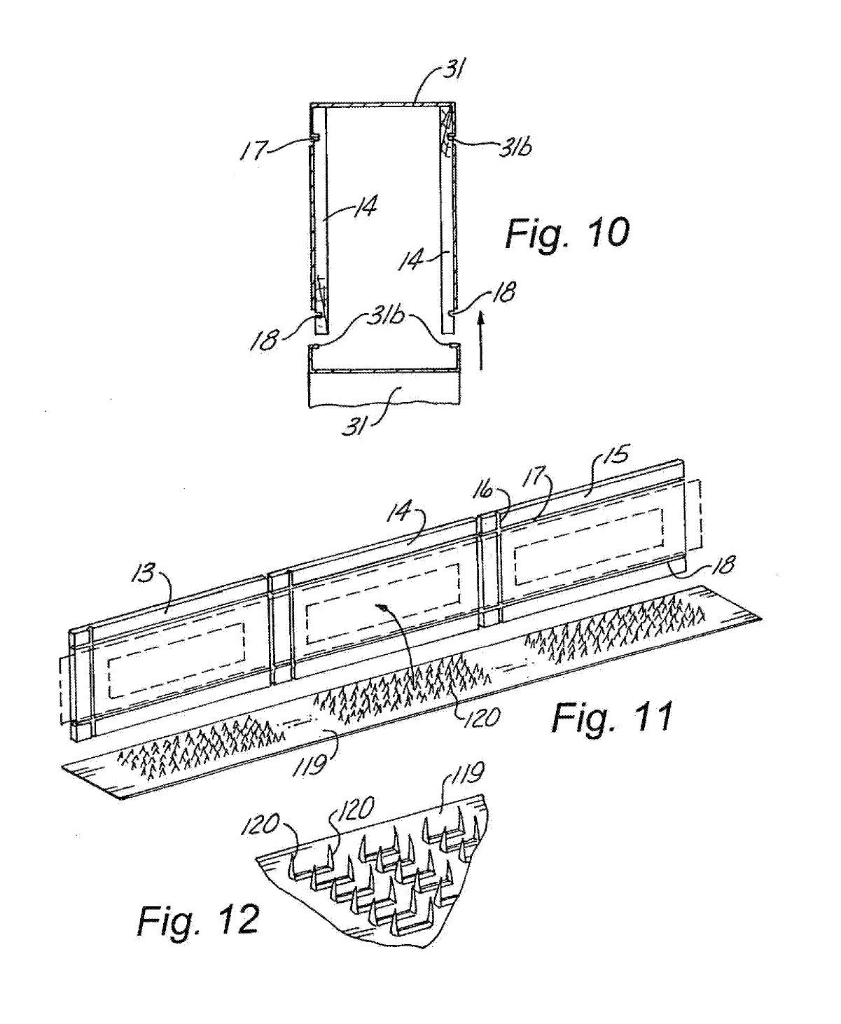

Referring now to FIG. 10, a cross sectional view, along lines 10-10 of FIG. 9 illustrate the structural components and how they interlock and support each other.

Referring to FIGS. 11 and 12, an alternate form of the one-piece hinge (119) is shown having a plurality of metal projections (120) to permit the hinge (19) to be placed in the position shown in dashed lines in FIG. 11 and then pressed into the backing members (13), (14) and (15). This structure is fully equivalent to using the screws (21) shown in FIG. 2. These projections (120) are similar to the projections in prior art plates used to construct trusses or the like.

Accordingly, it will be appreciated that the preferred embodiment does indeed accomplish the aforementioned objects. Obviously many modifications and variations of the present invention are possible in light of the above teachings. It is therefore to be understood that, within the scope of the appended claims, the invention may be practiced otherwise than as specifically described.

1-97. (canceled)

98. An apparatus comprising:
a first upright stud having a front leg, a rear leg, and an intermediate leg extending between said front and rear legs, the front leg of the first upright stud having a front surface disposed in a plane;
a second upright stud to one side of and spaced from said first stud said second stud having a front leg, a rear leg and an intermediate leg extending between said front and rear legs, the front leg of the second upright stud having a front surface disposed substantially in said plane; and
a backing member having a first end, a second end, a top, a bottom, a first side and a second side, said backing member being disposed between said first and second studs, a flange operatively attached to and extending in a plane substantially the same as or parallel to a plane of the first side of the backing member, said flange being attached to the front leg of said second upright stud, said first end of said backing member being operatively attached to the intermediate leg of said first upright stud, the plane of the first side of the backing member being substantially the same as said plane of the front leg of the first upright stud.

99. An apparatus comprising:
A backing member having a first end, a second end, a top, a bottom, a first side and a second side, said backing member being disposed between a first and second upright stud, a flange operatively attached to and extending in a plane substantially the same as or parallel to a plane of the first side of the backing member, said flange being attached to a front leg of said second upright stud, said first end of said backing member being operatively attached to an intermediate leg of said first upright stud, the plane of the first side of the backing member being substantially the same as the plane of a front leg of the first upright stud.

100. An apparatus comprising:
A backing member having a first end, a second end, a top, a bottom, a first side and a second side, said backing member being disposed between a first and second stud, a hinge operatively attached to and extending in a plane substantially the same as or parallel to a plane of the first side of the backing member, said hinge being attached to a front leg of said second stud, the plane of the first side of the backing member being substantially the same as the plane of the front leg of the first stud.

101. An apparatus comprising:
A backing member having a first end, a second end, a top, a bottom, a first side and a second side, said backing member being disposed between a first and second stud, a substantially planar structure operatively attached to and extending in a plane substantially the same as or parallel to a plane of the first side of the backing member, said substantially planar structure being attached to a front leg of said second stud, the plane of the first side of the backing member being substantially the same as the plane of the front leg of the first stud.

102. The apparatus of claim 98 further comprising a vertical groove in the backing member for receiving a flange of one of the upright studs.

103. The apparatus of claim 99 further comprising a vertical groove in the backing member for receiving a flange of one of the upright studs.

104. The apparatus of claim 100 further comprising a vertical groove in the backing member for receiving a flange of one of the studs.

105. The apparatus of claim 101 further comprising a vertical groove in the backing member for receiving a flange of one of the studs.

106. The apparatus of claim 100 wherein the hinge is also operatively attached to a front leg of said first stud.

107. The apparatus of claim 104 wherein the hinge is also operatively attached to a front leg of said first stud.

108. The apparatus of claim 101 wherein the substantially planar structure is also operatively attached to a front leg of said first stud.

109. The apparatus of claim 105 wherein the substantially planar structure is also operatively attached to a front leg of said first stud.

110. The apparatus of claim 98 wherein the backing member has a second flange attached to the front leg of said first upright stud.

111. The apparatus of claim 99 wherein the backing member has a second flange attached to the front leg of said first upright stud.

112. The apparatus of claim 102 wherein the backing member has a second flange attached to the front leg of said first upright stud.

113. The apparatus of claim 103 wherein the backing member has a second flange attached to the front leg of said first upright stud.

114-116. (canceled)
